(19) United States
(12) Patent Application Publication
(10) Pub. No.: US 2003/0139919 A1
(43) Pub. Date: Jul. 24, 2003

(54) Multi-user simulation

(75) Inventors: Oleg Sher, Givataim (IL); Avi Avitsror, Hadera (IL); Zuri Rubin, Matan (IL)

Correspondence Address: Fogg, Slifer & Polglaze. P.A, P.O. Box 581009, Minneapolis, MN, 55458-1009, US

(73) Assignee: ADC Telecommunications Israel Ltd.

(21) Appl. No.: 10/055,705

(22) Filed: Jan. 23, 2002

(51) Int. Cl. G06F 9/455

(52) U.S. Cl. 703/25

(57) ABSTRACT

A multi-user simulation system is provided. The multi-user simulation system utilizes a processing unit with multiple ports, the processing system being coupled via communications lines to a central unit. The processing system is adapted to execute test software and communicate to the central unit via the multiple ports to emulate multiple users of a communications network, thus simulating real-world loading conditions of the communication network. A method for testing the central unit is also disclosed.

### TECHNICAL FIELD

The present invention relates generally to the field of testing of electronic equipment, and in particular, to simulating multiple connections to the electronic equipment.

### BACKGROUND

Subscriber systems, such as digital subscriber line (DSL) networks, involve connecting multiple subscribers to an access network, such as an Internet service provider (ISP). Conventionally, information is transferred between an access network and the subscribers' equipment. The subscribers' equipment is located at a business or residential site. The multiple subscriber lines are usually connected to a central unit that connects the subscribers to the access network.

Units and systems such as those detailed above, and in particular those supporting DSL, are typically tested to determine loading on the system and system components, as well as the loading on the central unit, such as a digital subscriber line access multiplexer (DSLAM). Testing of this type of system requires multiple subscriber lines to simulate a real-world multi-user network environment. Simulation activities include Internet browsing, file transferring, video demanding, and video conferencing, simultaneously on each of multiple subscriber lines.

Currently, subscriber systems are often simulated by coupling multiple computers to a central unit of the subscriber system under test. Since each computer represents only one distinct Internet protocol (IP) address, it becomes necessary to dedicate a separate computer to simulate each subscriber line for the system under test. Each of these computers runs application programs during the testing. Thus, separate software licenses must be purchased for each application installed on each computer. Therefore, a multi-user simulation requires numerous computers, operating systems, application software, test simulation software, and monitors. High costs are thus incurred in acquiring, configuring and maintaining these computers. In addition, these types of test systems also consume large quantities of electrical power, occupy much space, and generate excessive noise and heat.

For the reasons stated above, and for other reasons stated below which will become apparent to those skilled in the art upon reading and understanding the present specification, there is a need in the art for improvements in test simulation in multi-user network systems.

### SUMMARY

The above-mentioned problems with testing electronic equipment and other problems are addressed by embodiments of the present invention and will be understood by reading and studying the following specification.

In one embodiment, a simulation unit contains a processing unit capable of executing test software. The processing unit is configured to have multiple ports, wherein each of the multiple ports represents a distinct IP address. The simulation unit emulates multiple network connections.

In another embodiment, a simulation system is provided. The simulation system includes a remote processing unit. The remote processing unit is adapted to couple to one or more simulation units. The simulation units each include a processing unit. The processing unit is configured to have multiple ports with each of the multiple ports representing a distinct Internet protocol address. Each simulation unit emulates multiple network connections. The simulation system emulates a large quantity of network connections.

### BRIEF DESCRIPTION OF THE DRAWINGS

FIG. 1 is a block diagram of one embodiment of a system that is adapted to function as a multi-user simulator, according to the teachings of this invention.

FIG. 2 is a flowchart of an embodiment of a process for testing a network according to the teachings of this invention.

FIG. 3 is a block diagram of another embodiment of a system that is adapted to function as a multi-user simulator, according to the teachings of this invention.

FIG. 4 is a flowchart of an embodiment of a process for testing large-scale networks according to the teachings of this invention.

### DETAILED DESCRIPTION

In the following detailed description of present embodiments, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the scope of the present invention. For example, the term xDSL used in the following description collectively includes any version of digital subscriber lines, such as asymmetric digital subscriber lines (ADSL), symmetric digital subscriber lines (SDSL), high-bit rate digital subscriber lines (HDSL), very high-speed digital subscriber lines (VDSL), consumer digital subscriber lines (CDSL), and others, which are well known to those skilled in the art or are later developed. The following detailed description is, therefore, not to be taken in a limiting sense, and the scope of the present invention is defined only by the claims and equivalents thereof.

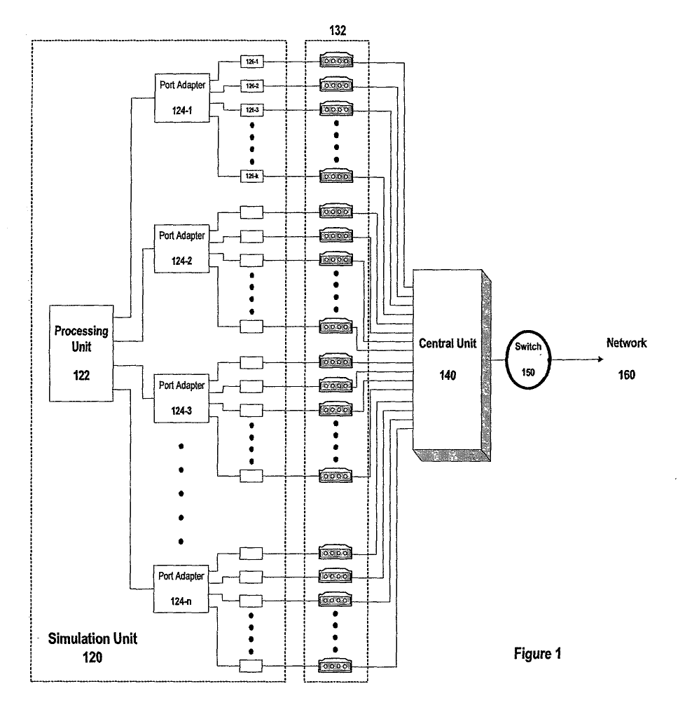

FIG. 1 details a block diagram of one embodiment of a simulation unit 120 that is adapted to function as a multi-user simulator, according to the teachings of this invention. The simulation unit 120 includes a processing unit 122. In one embodiment, the processing unit 122 is a personal computer (PC), capable of executing test software, and running a Windows 2000/XP operating system available from Microsoft Corporation of Redmond, Wash. In other embodiments, processing unit 122 uses a UNIX-like operating system, e.g., Linux, Solaris. In other embodiments, the processing unit 122 is a network server, mini-computer, terminal, mainframe, central processing unit (CPU), or the like. In yet another embodiment, the processing unit 122 is a workstation, which is a general-purpose computer designed to be used by one person at a time and which offers higher performance than currently found in a personal computer, especially with respect to graphics, processing power and the ability to carry out several tasks at the same time.

The processing unit 122 contains multiple port adapters 124-1 to 124-n. In one embodiment, the multiple port adapters 124-1 to 124-n each comprise a D-Link DFE-570TX Dual-Speed 4-port PCI Ethernet Server Adapter commercially available from D-Link Corporation of Irvine, Calif. In another embodiment, the multiple port adapters 124-1 to 124-n comprise any acceptable n-port Network Interface Card (NIC). Each of the multiple port adapters 124-1 to 124-n contains one or more ports 126-1 to 126-k. In one embodiment, the multiple port adapters 124-1 to 124-n containing one or more ports 126-1 to 126-k are installed in the processing unit 122. In another embodiment, the multiple port adapters 124-1 to 124-n containing one or more ports 126-1 to 126-k are located outside the processing unit 122. Each of the one or more ports 126-1 to 126-k represents a distinct Internet Protocol (IP) address. In one embodiment, each IP address is in a different sub-network. Thus, a single processing unit 122 is used to simulate a plurality of separate, independent connections, e.g., one connection per port 126-1 to 126-k of each of the multiple port adapters 124-1 to 124-n.

In one embodiment, the simulation unit 120 utilizes test execution software, such as WinRunner™ by Mercury Interactive Corporation, 1325 Borregas Avenue, Sunnyvale, Calif. or Rational Robot™ by Rational Software Corporation, 18880 Homestead Road, Cupertino, Calif., to simulate system loading created by multiple network connections, wherein each network connection is operating customer premises equipment. The system loading is performed by transferring information, including voice, data, and video, between the one or more ports 126-1 to 126-k and central unit 140. Customer premises equipment includes such devices as personal computers (PCs), network terminals, modems, telephones, video conferencing systems, video-on-demand (VOD) systems, facsimile (FAX) machines, and others. The test execution software simulates one or more of Internet browsing, file transferring, video conferencing, audio streaming, and others. In one embodiment, the test execution software is adapted to monitor network activity of the simulation system, allowing for statistical data of system performance to be collected. Advantageously, the simulation system thus simulates system loading by multiple network connections without the need to dedicate a separate processor, e.g., computer, to represent each network connection.

The one or more ports 126-1 to 126-k are coupled to a central unit 140 via a communications link 132. In one embodiment, communications link 132 includes one of an ADSL, a SDSL, a VDSL, and an HDSL modem. In other embodiments, communications link 132 includes any other acceptable communication device driven by an Ethernet or other networking interface. In one embodiment, central unit 140 is a multiplexer, such as a digital subscriber line access multiplexer (DSLAM), remote DSLAM, remote access multiplexer, or the like. Simulation unit 120 is used to test central unit 140 by simulating a plurality of connections to central unit 140 while using only a single processing unit 122.

In one embodiment, central unit 140 is coupled to a switch 150, such as an asynchronous transfer mode (ATM) switch, a digital switch, public switched telephone network (PSTN) switch, central office (CO) switch, dial-up switch, or the like. The switch 150 is coupled to a network 160. In one embodiment, the network 160 is the Internet. In other embodiments, the network 160 is an asynchronous transfer mode (ATM) system, a TCP/IP router, switched digital video (SDV) server, wireless system, LAN, intranet, or other network system.

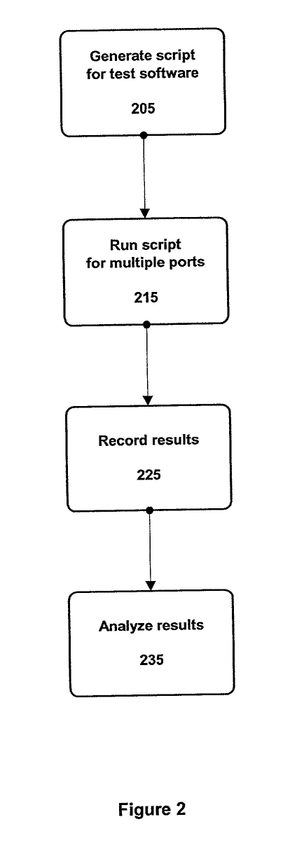

FIG. 2 is a flowchart that illustrates an embodiment of a process for testing telecommunications equipment, e.g., central unit 140 of FIG. 1, according to the teachings of this invention. In operation, the method begins at block 205, where a script is generated for test software in processing unit 122. In one embodiment, the script is generated using the Win Runner software. The method proceeds to block 215, where the processing unit 122 runs the script for one or more ports 126-1 to 126-k. Central unit 140 recognizes each of the one or more ports 126-1 to 126-k as a distinct IP address. Communication of information is established between each of the one or more ports 126-1 to 126-k and the central unit 140. The test software simulates real network activities, such as one or more of file transferring, video conferencing, Internet browsing, audio and video streaming, and others. The simulation of real network activities creates a simulation of system loading. The simulation of system loading includes one or more of transferring information between the one or more ports 126-1 to 126-k and the central unit 140, storing information in memory of the processing unit 122, repeating the transferring of information between the one or more ports 126-1 to 126-k and the central unit 140, and outputting the information. The method proceeds to block 225, where test results of the transfer of information between the one or more ports 126-1 to 126-k and the central unit 140 are recorded. The method proceeds to block 235, where the results of testing are analyzed.

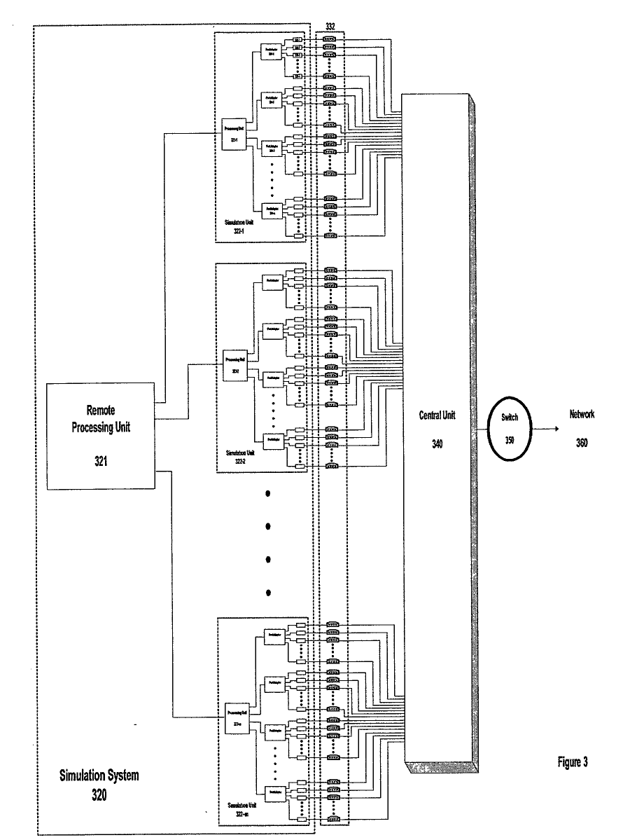

FIG. 3 details a block diagram of another embodiment of a system 320 that is adapted to function as a multi-user simulator, according to the teachings of this invention. In this embodiment, the test software is executed by a remote processing unit 321, such as a network server, central processing unit, PC, or similar. In one embodiment, the simulation unit 320 uses test execution software, such as WinRunner™ or LoadRunner™ by Mercury Interactive Corporation, 1325 Borregas Ave., Sunnyvale, Calif., or Rational Robot™ by Rational Software Corporation, 18880 Homestead Road, Cupertino, Calif., or similar. The remote processing unit 321 is coupled to one or more simulation units 322-1 to 322-m. Each of simulation units 322-1 to 322-m includes a corresponding processing unit 323-1 to 323-m, respectively. The processing units 323-1 to 323-m each include multiple port adapters 324-1 to 324-n. Each of the multiple port adapters 324-1 to 324-n contains one or more ports 326-1 to 326-k. The one or more ports 326-1 to 326-k are coupled to a central unit 340 via a communications links 332. The central unit 340 is coupled to a network 360 via a switch 350. Thus, this embodiment simulates a plurality of separate, m X n X k, independent connections toward network 360.

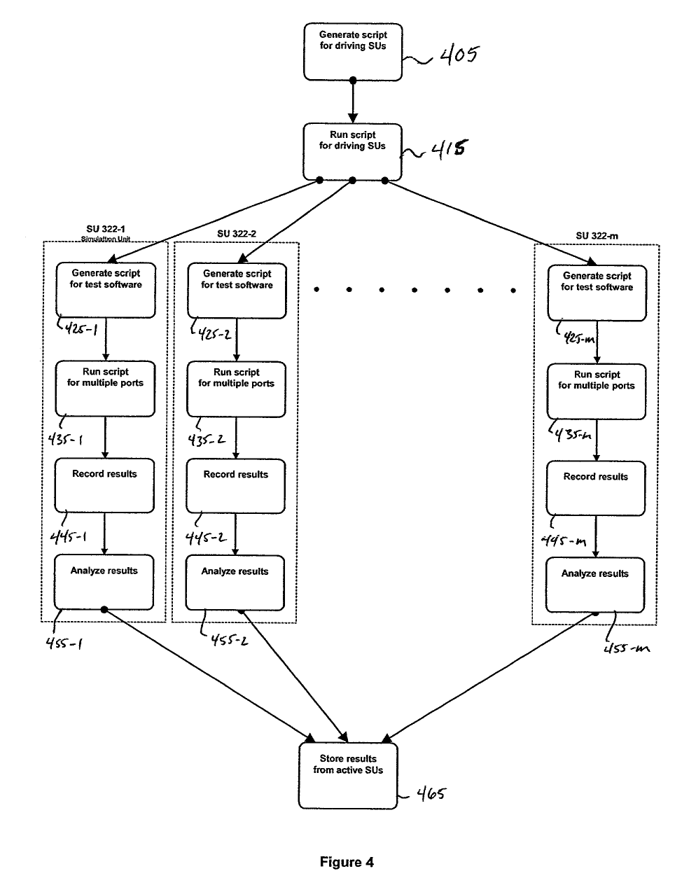

In the embodiment shown in FIG. 3, the method begins at block 405, as illustrated in FIG. 4. At block 405, a script is generated for initializing, activating and controlling simulation units 322-1 to 322-m. The method proceeds to block 415 where remote processing unit 321 runs the script that activates one or more simulation units 322-1 to 322-m. The method proceeds to blocks 425-1 to 425-m. In each of the activated simulation units 322-1 to 322-m, a script is generated for test software. The method proceeds to blocks 435-1 to 435-m, where the active processing units 323-1 to 323-m run the script for one or more of their respective ports 326-1 to 326-k. Central unit 340 recognizes each of the one or more ports 326-1 to 326-k as a distinct IP address. Communication of information is established between each of the one or more ports 326-1 to 326-k and the central unit 340. The test software simulates real network activities, such as one or more of file transferring, video conferencing, Internet browsing, audio and video streaming, and others. The method proceeds to blocks 445-1 to 445-m, where results of testing are recorded at processing units 323-1 to 323-m of the active simulation units. The method proceeds to blocks 455-1 to 455-m, where the results of testing are analyzed by processing units 323-1 to 323-m of the active simulation units. The method ends in block 465, where all analyzed results are accumulated and stored in the remote processing unit 321.

### CONCLUSION

Although specific embodiments have been illustrated and described herein, it will be appreciated by those of ordinary skill in the art that any arrangement, which is calculated to achieve the same purpose, may be substituted for the specific embodiments shown. For example, the types of communication links that couple the multiple ports to the central unit may include copper wire, cable, fiber optic, infrared, wireless, or the like. This application is intended to cover any adaptations or variations of the present invention. Therefore, it is intended that this invention be limited only by the claims and the equivalents thereof.

What is claimed is:

1. A simulation unit comprising:
a processing unit;
wherein the processing unit is configured to have multiple ports;
wherein each of the multiple ports represents a distinct Internet protocol address; and
wherein the simulation unit emulates multiple network connections.

2. A simulation unit adapted to couple to a central unit, it comprising:
a processing unit;
at least two port adapters coupled to the processing unit, wherein each port adapter includes one or more ports adapted to be coupled to the central unit; and
wherein each of the one or more ports represents a distinct Internet protocol address and simulates a separate connection to the central unit.

3. The simulation unit of claim 2, wherein the simulation unit is adapted to execute a test software program.

4. The simulation unit of claim 2, wherein each of the one or more ports is coupled to the central unit using a digital subscriber line.

5. The simulation unit of claim 2, wherein the processing unit utilizes test execution software to simulate transfer of information between the one or more ports and the central unit.

6. The simulation unit of claim 2, wherein the processing unit simulates system loading by transferring information between the one or more ports and an access network via digital subscriber lines.

7. The simulation unit of claim 2, wherein the central unit is one of a digital subscriber line access multiplexer, and a remote digital subscriber line access multiplexer.

8. The method of claim 6, further comprising recording and repeating the transfer of information between the one or more ports and the central unit.

9. The method of claim 6, wherein transferring information comprises transferring one or more of voice, data, and video information.

10. A method of testing by simulating an access network, the method comprising:
using a processing unit for generating a script for a test software program, the processing unit having at least two port adapters, each of the at least two port adapters having one or more ports, and each of the one or more ports having a distinct Internet protocol address; and
running the script for the test software program for each of the one or more ports, wherein running the script includes:
recognizing each of the one or more ports as a distinct Internet protocol address;
establishing communication between the one or more ports and a central unit; and
generating a transfer of information between the one or more ports and the central unit.

11. The method of claim 10, wherein generating the transfer of information between the one or more ports and the central unit includes generating the transfer of one or more of voice, data, and video information.

12. The method of claim 10, further comprising recording and repeating the transfer of information between the one or more ports and the central unit.

13. A method of testing by simulating an access network, the method comprising: executing a test software program using a processing unit having at least two port adapters and each of the at least two port adapters having one or more ports;
recognizing each of the one or more ports via a distinct Internet protocol address;
establishing communication between the one or more ports and a central unit; and
creating a simulation of system loading, that includes:
transferring information between the one or more ports and the central unit,
storing information in memory of the processing unit,
repeating the transferring of the information between the one or more ports and the central unit,
analyzing the stored information; and
outputting the results.

14. A simulation system comprising:
a remote processing unit;
wherein the remote processing unit is adapted to couple to one or more simulation units;
each of the one or more simulation units comprising:
a processing unit;
wherein the processing unit is configured to have multiple ports;
wherein each of the multiple ports represents a distinct Internet protocol address; and
wherein each simulation unit emulates multiple network connections.

15. A simulation system adapted to couple to a central unit, the simulation system comprising:
a remote processing unit; and
one or more simulation units, coupled to the remote processing unit, each simulation unit comprising:
a processing unit;
at least two port adapters coupled to the processing unit, wherein each port adapter includes one or more ports adapted to be coupled to the central unit; and
wherein each of the one or more ports represents a distinct Internet protocol address and simulates a separate connection to the central unit.

16. The simulation system of claim 15, wherein the simulation system is adapted to execute a script to initialize, activate and control one or more simulation units.

17. The simulation system of claim 15, wherein the remote processing unit is coupled to the processing unit of the one or more simulation units.

18. The simulation system of claim 15, wherein the simulation unit is adapted to execute a test software program.

19. The simulation system of claim 15, wherein each of the one or more ports is coupled to the central unit using a digital subscriber line.

20. The simulation system of claim 15, wherein the processing unit utilizes test execution software to simulate transfer of information between the one or more ports and the central unit.

21. The simulation system of claim 15, wherein the processing unit simulates system loading by transferring information between the one or more ports and an access network via digital subscriber lines.

22. The simulation system of claim 15, wherein the central unit is one of a digital subscriber line access multiplexer, and a remote digital subscriber line access multiplexer.

23. The simulation unit of claim 15, wherein each of the one or more ports is coupled to the central unit using a digital subscriber line.

24. The simulation unit of claim 15, wherein the processing unit utilizes test execution software to simulate transfer of information between the one or more ports and the central unit.

25. The simulation unit of claim 15, wherein the processing unit simulates system loading by transferring one or more of data, video, and voice, between the one or more ports and an access network via a digital subscriber line.

26. A method of simulating an access network, the method comprising:
generating a script for initializing, activating and controlling one or more simulation units using a remote processing unit;
generating a script for a test software program in each of the active simulation units using a processing unit having at least two port adapters, each of the at least two port adapters having one or more ports, and each of the one or more ports having a distinct Internet protocol address; and
running the script for the test software program for each of the one or more ports, wherein running the script includes:
recognizing each of the one or more ports as a distinct Internet protocol address;
establishing communication between the one or more ports and a central unit; and
generating a transfer of information between the one or more ports and the central unit.

27. The method of claim 26, further comprising recording and repeating the transfer of information between the one or more ports and the central unit of the active simulation units.

28. The method of claim 26, wherein transferring information comprises transferring one or more of voice, data, and video information.

29. A method of testing by simulating an access network, the method comprising:
initializing, activating and controlling a processing unit of one or more simulation units by a remote processing unit;
executing a test software program using a processing unit of active simulation units having at least two port adapters and each of the at least two port adapters having one or more ports;
recognizing each of the one or more ports via a distinct Internet protocol address;
establishing communication between the one or more ports and a central unit;
creating a simulation of system loading, that includes:
transferring information between the one or more ports and the central unit,
storing information in memory of the processing unit,
repeating the transferring of the information between the one or more ports and the central unit, and
recording and analyzing the stored information;
storing all analyzed results in the remote processing unit; and
outputting the results.
